(19) United States
(12) Patent Application Publication
(10) Pub. No.: US 2025/0390584 A1
(43) Pub. Date: Dec. 25, 2025

(54) USING AN LLM TO GENERATE API AND APPLICATION VULNERABILITY MITIGATION POLICIES FOR API GATEWAYS, WEB APPLICATION FIREWALLS, NEXT GENERATION FIREWALLS, AND IPS/IDS TOOLS

(71) Applicant: Wallarm Inc., San Francisco, CA (US)

(72) Inventor: Ivan Novikov, San Francisco, CA (US)

(21) Appl. No.: 19/240,524

(22) Filed: Jun. 17, 2025

Related U.S. Application Data
(60) Provisional application No. 63/662,186, filed on Jun. 20, 2024.

(51) Int. Cl. G06F 21/57

(52) U.S. Cl. CPC G06F 21/577

(57) ABSTRACT

The method for generating mitigation policies may include receiving, by a large language model (LLM), a plurality of inputs including textual description of vulnerabilities, code with one or more vulnerability exploits, and meta-data; generating, by the LLM, API and application vulnerability mitigation policies based on the received inputs; generating, by a feedback loop automation engine (FLAE), feedback data based on the API and application vulnerability mitigation policies and the code with one or more vulnerability exploits; and updating, by the LLM, the API and application vulnerability mitigation policies based on the feedback data generated by the FLAE.

### RELATED APPLICATION

This application is a non-provisional patent application of and claims priority to U.S. Provisional Application No. 63/662,186, filed 20 Jun. 2024, which is incorporated herein by reference in its entirety.

### FIELD OF THE INVENTION

The present invention relates to use of large language models (LLMs) with an automated feedback loop to mitigate vulnerabilities in application programming interfaces (APIs) and applications.

### BACKGROUND

Application and API vulnerabilities are common issues for enterprise software and hardware. Mitigation of such vulnerabilities when they are discovered is an important task that is not presently solved in an automated way.

### SUMMARY OF THE INVENTION

In accordance with one embodiment of the invention, API and application vulnerability mitigation policies are automatically generated by a computer-implemented method that comprises receiving, by a large language model (LLM), a plurality of inputs including textual description of vulnerabilities, code with one or more vulnerability exploits, and meta-data; generating, by the LLM, API and application vulnerability mitigation policies based on the received inputs; generating, by a feedback loop automation engine (FLAE), feedback data based on the API and application vulnerability mitigation policies and the code with one or more vulnerability exploits; and updating, by the LLM, the API and application vulnerability mitigation policies based on the feedback data generated by the FLAE.

These and other embodiments of the invention are more fully described in association with the drawings below.

### BRIEF DESCRIPTION OF THE DRAWINGS

The invention is now described, by way of example and without limiting the scope of the invention, with reference to the accompanying drawings which illustrate embodiments of it, in which:

FIG. 1 depicts a system that implements a schema with three stages (i.e., stage 1—generate initial policy, stage 2—run such policy, run exploit, generate feedback for stage 3 if required, i.e., exploit still works with mitigation policy applied), in accordance with one embodiment of the invention.

FIG. 2 depicts a flow diagram 200 of a computer-implemented method for generating API and application vulnerability mitigation policies, in accordance with one embodiment of the invention.

FIG. 3 depicts components of a computer system in which computer readable instructions instantiating the methods of the present invention may be stored and executed.

### DETAILED DESCRIPTION

To address such shortcomings in the art, the present invention provides for using LLMs (Large Language Models) with an automated feedback loop to generate mitigation policies, optionally in addition to a usual human-supervised automation that is widely implemented nowadays.

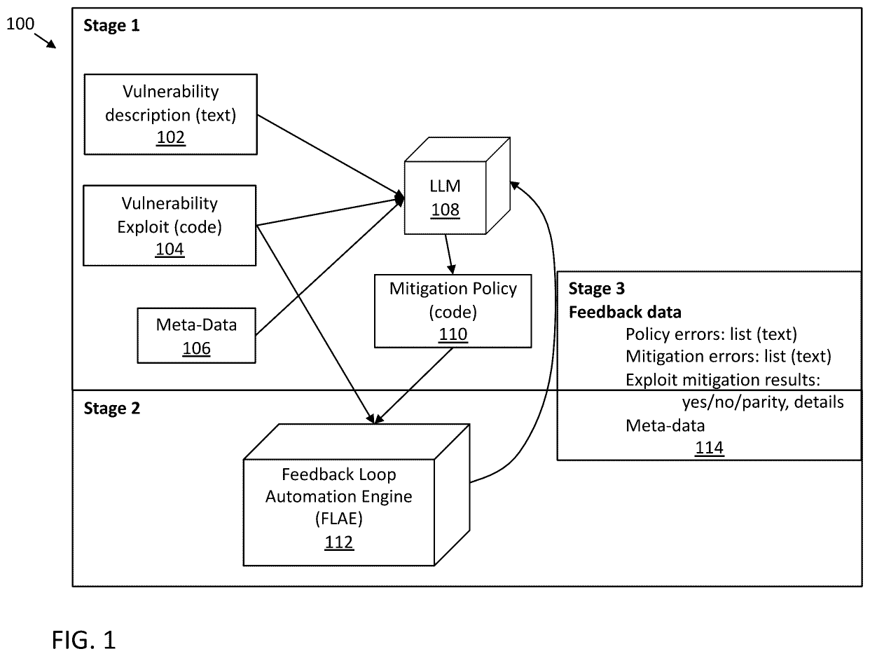

The LLM-based approach to generating mitigation policies leverages advanced machine learning models to automate the creation of security configurations for API gateways, Web Application Firewalls (WAF), Next Generation Firewalls (NGFW), and Intrusion Prevention/Detection Systems (IPS/IDS). As depicted in the system 100 of FIG. 1, embodiments of the present method utilize detailed inputs, including textual description of vulnerabilities 102, exploit examples (in the form of computer code) 104, meta-data 106 (e.g., including infrastructure details), processed through system and user prompts. By integrating these elements, the LLM 108 generates precise and effective mitigation policies 110 tailored to the specific technical environment. This innovative approach not only streamlines the policy generation process but also enhances the overall security posture by ensuring that the policies 110 are comprehensive, accurate, and continuously refined through an automated feedback loop 114.

### Inputs:

Manually created and validated policies for well-known vulnerabilities (CVEs) with their exploits and step-by-step guides on its reproduction (as a reference) 102.

### Vulnerability Details with Exploit Example 104

### Meta-Data 106:

a. Detailed information about API gateway or other solution to generate a policy for, including version, implementation option, blocking mode, and other.
b. Technical infrastructure information, such as IP addresses, netmasks, connectivity schema, used encryptions, and other.
c. Notation of error handling, exceptions/error codes.
d. User-defined extra requirements and meta-data.

### Output:

Code 110 of policy/configuration file required to implement such mitigation.

### Feedback Loop 114 to LLM 108:

The feedback loop 114 to LLM 108 is an essential component of the mitigation policy generation process, ensuring continuous refinement and improvement of the policies. This loop integrates real-time feedback 114 from the deployment and testing of the generated policies, feeding data back into the LLM 108 to enhance its accuracy and effectiveness. Key feedback elements 114 include policy errors, mitigation errors, and exploit mitigation results, alongside relevant meta-data. By automating this feedback mechanism through the Feedback Loop Automation Engine (FLAE) 112, the system 100 can dynamically adapt and improve, addressing any issues identified during policy implementation and ensuring that the mitigation strategies remain robust and effective against evolving threats.

### Example Use Case: MuleSoft® and Weak JavaScript® Object Notation (JSON) Web Token (JWT) Secret

The following example is provided to demonstrate a real-world scenario involving MuleSoft® (a platform developed by Salesforce® Inc. of San Francisco, CA that enables organizations to connect data, systems, and AI models to automate tasks, streamline processes, and improve customer experiences), where a weak JWT secret poses a security vulnerability. To address this issue, the LLM-based mitigation policy generation process is utilized, leveraging ChatGPT® (from OpenAI, Inc. of San Francisco, CA) as the core LLM 108. Other LLMs 108 may also be used.

### First Iteration: Initial Policy Generation

In the first iteration, ChatGPT® is provided with the following detailed inputs:
Vulnerability Description: Weak JWT secret used in MuleSoft's® authentication process, with no signing algorithm specified in the “alg” header.
Exploit Example: JWT with “alg”: “none”, leading to potential security breaches.
Meta-Data: Domain information (api4(dot)demo(dot)wallarm(dot)com), discovery date (3 Dec. 2022), and other relevant details.
Technical Infrastructure: Details such as IP addresses, netmasks, connectivity schemas, and encryption methods.

Using these inputs, ChatGPT® generates an initial mitigation policy. This policy includes:
Schema Validation: Ensuring the JWT header contains only allowed algorithms (RS256) and the type (JWT).
Extract and Decode JWT: Extracting the Authorization header and decoding the JWT to access its header.
Validation Logic: Verifying that the alg field in the JWT header is RS256. If not, raising an error.

Here's the initial MuleSoft® policy generated:

```
<?xml version=“1.0” encoding=“UTF-8”?>
<mule-policy xmlns=“http://www(dot)mulesoft(dot)org/schema/mule/policy”
xmlns:xsi=“http://www(dot)w3(dot)org/2001/XMLSchema-instance”
xmlns:json=“http://www(dot)mulesoft(dot)org/schema/mule/json”
xmlns:dw=“http://www(dot)mulesoft(dot)org/schema/mule/ee/dw”>
  <configuration>
    <json:validate-schema doc:name=“Validate JWT Header”
        <json:schema>
            <![CDATA[
            {
                “type”: “object”,
                “properties”: {
                “alg”: {
                    “type”: “string”,
                    “enum”: [“RS256”]
                  },
                  “typ”:{
                    “type”: “string”,
                    “enum”: [“JWT”]
                  }
                },
                “required”: [“alg”, “typ”]
              }
              ]]>
            </json:schema>
          </json:validate-schema>
        </configuration>
        <on-request>
            <set-variable value=“#[attributes.headers[‘Authorization’]]”
        variableName=“authHeader” doc:name=“Extract Authorization
        Header”/>
            <json:decode-transform doc:name=“Decode JWT Header”
        returnClass=“java.util.HashMap”>
            <json:input><![CDATA[
              #[dw::core::Binaries::fromBase64(authHeader splitBy
          ‘.’)[0] as String]
            ]]></json:input>
          </json:decode-transform>
          <json:validate-schema doc:name=“Validate JWT Header
        Schema”>
            <json:content><![CDATA[#[vars.authHeader]]]></json:co
        ntent>
          </json:validate-schema>
          <choice doc:name=“Validate JWT Algorithm”>
            <when expression=“#[vars.authHeader[‘alg’] != ‘RS256’]”>
                <raise-error type=“INVALID_ALG”
            description=“Invalid JWT Algorithm”/>
            </when>
          </choice>
        </on-request>
      </mule-policy>
```

### Second Iteration: Policy Refinement

After deploying the initial policy, the feedback loop collects data on its effectiveness. The initial deployment encounters several issues:
a. Syntax Errors: Incorrect syntax in the Data Weave script used to decode the JWT header.
b. Policy Errors: Misconfiguration in the JSON schema validation causing incorrect parsing of JWT headers.
c. Mitigation Errors: Specific errors encountered during JWT validation due to incomplete handling of edge cases.
d. Exploit Mitigation Results: Some edge cases still allowed bypassing the validation due to incorrect handling of the alg parameter.

The LLM 108 (e.g., ChatGPT®) processes this feedback and identifies the issues. The refined policy addresses these problems by:
a. Correcting Syntax Errors: Fixing the Data Weave script to correctly decode the JWT header.
b. Improving JSON Schema Validation: Adjusting the JSON schema to ensure accurate validation of the JWT header.
c. Comprehensive Validation Checks: Ensuring all possible edge cases are covered in the validation logic.
d. Implementing Additional Logging: Capturing any anomalies during the JWT validation process for further analysis.

Here is the refined MuleSoft® policy:

```
<?xml version=“1.0” encoding=“UTF-8”?>
<mule-policy xmlns=“http://www(dot)mulesoft(dot)org/schema/mule/policy”
xmlns:xsi=“http://www(dot)w3(dot)org/2001/XMLSchema-instance”
xmlns:json=“http://www(dot)mulesoft(dot)org/schema/mule/json”
xmlns:dw=“http://www(dot)mulesoft(dot)org/schema/mule/ee/dw”>
  <configuration>
    <json:validate-schema doc:name=“Validate JWT Header”
        <json:schema>
            <![CDATA[
            {
                “type”: “object”,
                “properties”: {
                  “alg”: {
                    “type”: “string”,
                    “enum”: [“RS256”]
                  },
                  “typ”: {
                    “type”: “string”,
                    “enum”: [“JWT”]
                  }
                },
                “required”: [“alg”, “typ”]
              }
              ]]>
            </json:schema>
          </json:validate-schema>
        </configuration>
        <on-request>
            <set-variable
        value=“#[attributes.headers[‘Authorization’].split(‘ ’)[1]]”
        variableName=“authHeader” doc:name=“Extract Authorization
        Header”/>
            <json:decode-transform doc:name=“Decode JWT Header”
        returnClass=“java.util.HashMap”>
            <json:input><![CDATA[
              #[dw::core::Binaries::fromBase64(authHeader splitBy
          ‘.’)[0] as String]
            ]]></json:input>
          </json:decode-transform>
          <json:validate-schema doc:name=“Validate JWT Header”>
        Schema”>
            <json:content> <![CDATA[#[vars.authHeader]]]></json:co
        ntent>
          </json:validate-schema>
          <choice doc:name=“Validate JWT Algorithm
            <when expression=“#[vars.authHeader.alg != ‘RS256’]”>
                <raise-error type=“INVALID_ALG”
            description=“Invalid JWT Algorithm”/>
            </when>
          </choice>
        </on-request>
      </mule-policy>
```

### Third Iteration: Final Check

The FLAE 112 tested such a policy and exploited an example and returned success. No more iterations are required.

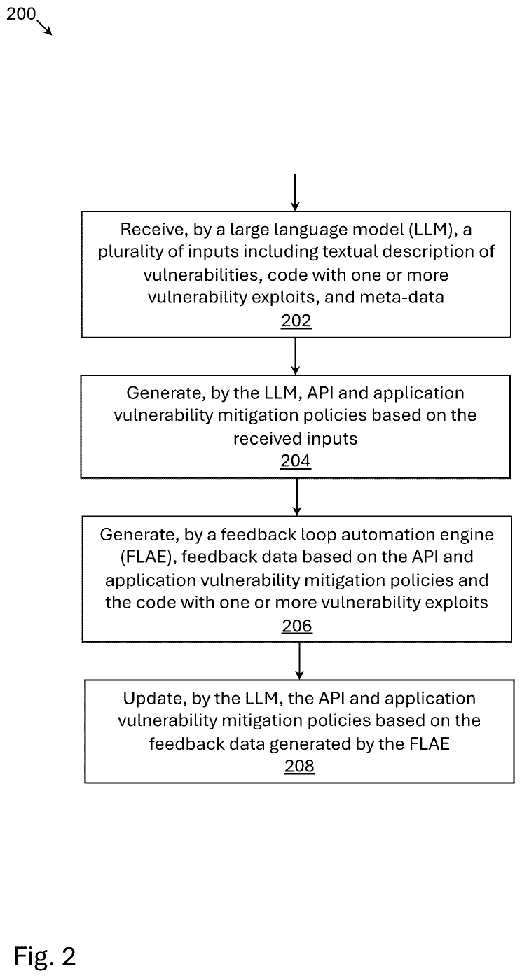

FIG. 2 depicts a flow diagram 200 of a computer-implemented method for generating API and application vulnerability mitigation policies. In step 202, an LLM may receive a plurality of inputs including textual description of vulnerabilities, code with one or more vulnerability exploits, and meta-data. The textual description of vulnerabilities may include manually created and validated policies for vulnerabilities (CVEs) with their exploits and step-by-step guides on its reproduction. The meta-data may include one or more of information regarding the API, technical infrastructure information, notation of error handling, notation of exceptions/error codes, or user-defined extra requirements.

In step 204, the LLM may generate API and application vulnerability mitigation policies based on the received inputs.

In step 206, a feedback loop automation engine (FLAE) may generate feedback data based on the API and application vulnerability mitigation policies and the code with one or more vulnerability exploits. The feedback data may include one or more of policy errors, mitigation errors, or exploit mitigation results.

In step 208, the LLM may update the API and application vulnerability mitigation policies based on the feedback data generated by the FLAE.

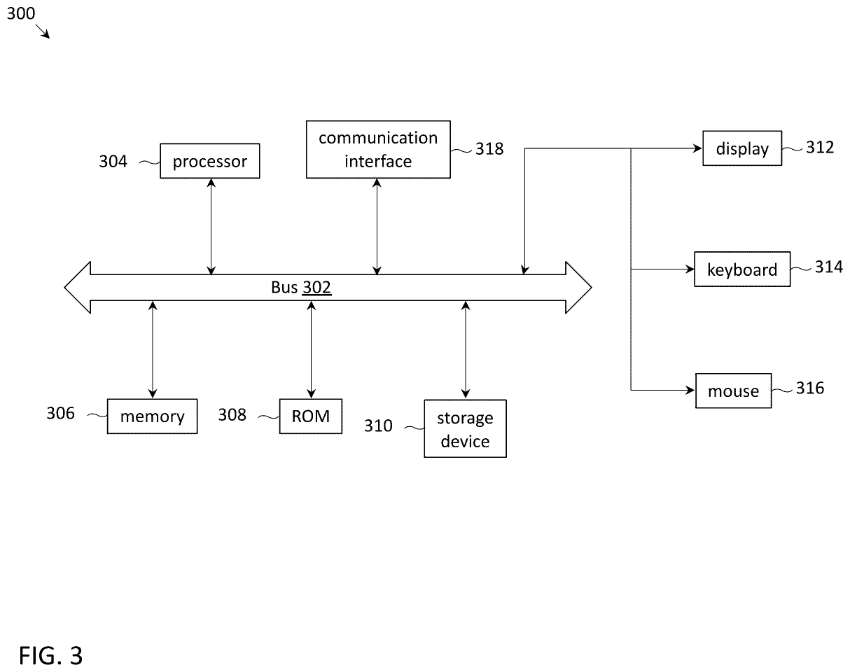

As is apparent from the foregoing discussion, aspects of the present invention involve the use of various computer systems and computer readable storage media having computer-readable instructions stored thereon. FIG. 3 provides an example of a system 300 that may be representative of any of the computing systems discussed herein (e.g., system 100). Examples of system 300 may include a smartphone, a desktop, a laptop, a mainframe computer, an embedded system, etc. Note, not all of the various computer systems have all of the features of system 300. For example, certain ones of the computer systems discussed above may not include a display inasmuch as the display function may be provided by a client computer communicatively coupled to the computer system or a display function may be unnecessary. Such details are not critical to the present invention.

System 300 includes a bus 302 or other communication mechanism for communicating information, and a processor 304 coupled with the bus 302 for processing information. Computer system 300 also includes a main memory 306, such as a random access memory (RAM) or other dynamic storage device, coupled to the bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to the bus 302 for storing static information and instructions for the processor 304. A storage device 310, for example a hard disk, flash memory-based storage medium, or other storage medium from which processor 304 can read, is provided and coupled to the bus 302 for storing information and instructions (e.g., operating systems, applications programs and the like).

Computer system 300 may be coupled via the bus 302 to a display 312, such as a flat panel display, for displaying information to a computer user. An input device 314, such as a keyboard including alphanumeric and other keys, may be coupled to the bus 302 for communicating information and command selections to the processor 304. Another type of user input device is cursor control device 316, such as a mouse, a trackpad, or similar input device for communicating direction information and command selections to processor 304 and for controlling cursor movement on the display 312. Other user interface devices, such as microphones, speakers, etc. are not shown in detail but may be involved with the receipt of user input and/or presentation of output.

The processes referred to herein may be implemented by processor 304 executing appropriate sequences of computer-readable instructions contained in main memory 306. Such instructions may be read into main memory 306 from another computer-readable medium, such as storage device 310, and execution of the sequences of instructions contained in the main memory 306 causes the processor 304 to perform the associated actions. In alternative embodiments, hard-wired circuitry or firmware-controlled processing units may be used in place of or in combination with processor 304 and its associated computer software instructions to implement the invention. The computer-readable instructions may be rendered in any computer language.

In general, all of the above process descriptions are meant to encompass any series of logical steps performed in a sequence to accomplish a given purpose, which is the hallmark of any computer-executable application. Unless specifically stated otherwise, it should be appreciated that throughout the description of the present invention, use of terms such as “processing”, “computing”, “calculating”, “determining”, “displaying”, “receiving”, “transmitting” or the like, refer to the action and processes of an appropriately programmed computer system, such as computer system 300 or similar electronic computing device, that manipulates and transforms data represented as physical (electronic) quantities within its registers and memories into other data similarly represented as physical quantities within its memories or registers or other such information storage, transmission or display devices.

Computer system 300 also includes a communication interface 318 coupled to the bus 302. Communication interface 318 may provide a two-way data communication channel with a computer network, which provides connectivity to and among the various computer systems discussed above. For example, communication interface 318 may be a local area network (LAN) card to provide a data communication connection to a compatible LAN, which itself is communicatively coupled to the Internet through one or more Internet service provider networks. The precise details of such communication paths are not critical to the present invention. What is important is that computer system 300 can send and receive messages and data through the communication interface 318 and in that way communicate with hosts accessible via the Internet. It is noted that the components of system 300 may be located in a single device or located in a plurality of physically and/or geographically distributed devices.

Thus, a computer-implemented method using an LLM to generate API and application vulnerability mitigation policies for API gateways, web application firewalls, next generation firewalls, and IPS/IDS tools has been described. It is to be understood that the above-description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A computer-implemented method for generating application programming interface (API) and application vulnerability mitigation policies, the method comprising:
receiving, by a large language model (LLM), a plurality of inputs including textual description of vulnerabilities, code with one or more vulnerability exploits, and meta-data;
generating, by the LLM, API and application vulnerability mitigation policies based on the received inputs;
generating, by a feedback loop automation engine (FLAE), feedback data based on the API and application vulnerability mitigation policies and the code with one or more vulnerability exploits; and
updating, by the LLM, the API and application vulnerability mitigation policies based on the feedback data generated by the FLAE.

2. The computer-implemented method of claim 1, wherein the textual description of vulnerabilities comprises manually created and validated policies for vulnerabilities (CVEs) with their exploits and step-by-step guides on its reproduction.

3. The computer-implemented method of claim 1, wherein the meta-data comprises one or more of information regarding the API, technical infrastructure information, notation of error handling, notation of exceptions/error codes, or user-defined extra requirements.

4. The computer-implemented method of claim 1, wherein the feedback data comprises one or more of policy errors, mitigation errors, or exploit mitigation results.

5. A non-transitory computer-readable medium comprising instructions that, when executed by a processor, cause the processor to:
receive, by a large language model (LLM), a plurality of inputs including textual description of vulnerabilities, code with one or more vulnerability exploits, and meta-data;
generate, by the LLM, API and application vulnerability mitigation policies based on the received inputs;
generate, by a feedback loop automation engine (FLAE), feedback data based on the API and application vulnerability mitigation policies and the code with one or more vulnerability exploits; and
update, by the LLM, the API and application vulnerability mitigation policies based on the feedback data generated by the FLAE.

6. The non-transitory computer-readable medium of claim 5, wherein the textual description of vulnerabilities comprises manually created and validated policies for vulnerabilities (CVEs) with their exploits and step-by-step guides on its reproduction.

7. The non-transitory computer-readable medium of claim 5, wherein the meta-data comprises one or more of information regarding the API, technical infrastructure information, notation of error handling, notation of exceptions/error codes, or user-defined extra requirements.

8. The non-transitory computer-readable medium of claim 5, wherein the feedback data comprises one or more of policy errors, mitigation errors, or exploit mitigation results.
